(19) United States
(12) Patent Application Publication
(10) Pub. No.: US 2012/0215054 A1
(43) Pub. Date: Aug. 23, 2012

(54) Hospital Equipment and Incubator

(75) Inventor: Djalma Luiz Rodrigues, Sao Paulo (BR)

(73) Assignee: FANEM LTDA., Sao Paulo (BR)

(21) Appl. No.: 13/278,915

(22) Filed: Oct. 21, 2011

(30) Foreign Application Priority Data
Oct. 21, 2010 (BR) PI1004020-0

(51) Int. Cl. A61G 11/00

(52) U.S. Cl. 600/22

(57) ABSTRACT

The present invention refers to hospital equipment, comprising at least an incubator of the closed kind having at least a side wall and at least a lid or dome, thereby defining a cabin inside of which there is provided at least a bed to receive at least a patient, at least one of the walls and/or dome being transparent, operatively associable to, at least, phototherapy equipment, and additionally comprising a film with anti-fog properties associated to at least one of the side walls and/or the dome.

### CROSS REFERENCE TO RELATED APPLICATION

This application claims priority to Brazilian Patent Application No. PI1004020-0, filed Oct. 21, 2010, which is incorporated herein by reference, together with any and all attachments and exhibits thereto. The full benefit and priority of this application is claimed.

### BACKGROUND

1. Field

The present invention refers to hospital equipment, like a closed incubator, idealized for the treatment of newly-borns (neonates), having a plurality of equipment to support the life of the patient, such as at least phototherapy equipment, as well as an antifog film that prevents fogging of the walls and dome of the incubator, guaranteeing both the complete visualization of the patient and the maintenance and effectiveness of the irradiance levels promoted by the phototherapy equipment even in internal conditions of high humidity. The present invention also refers to the incubator configuration itself, which increases the effectiveness of the treatments.

2. Description of Related Art

Incubators are hospital equipment designed to offer a climatized environment for newly-borns who, among other disturbances, are incapable of regulating their own temperature. The microclimate of incubators must have temperature conditions similar to those found in the mother's uterus, suitable relative air humidity and filtered air/oxygen flow, thus contributing to overcome clinical intercurrences and continued evolution of the status of the neonate without sequelae.

For providing thermoregulation conditions that meet the heat needs of newly-borns, these equipment may be found on the market going by the name of heated cribs. Generally, such incubators have three main portions which form the structure of conventional equipment. The lower portion is associated to a structure interconnected to horizontal arms connected to swivel wheels which support the weight of the incubator and enable movement thereof; a second portion projected vertically beyond the level of the incubator supports the installations and instruments needed for neonatal life support; and the third portion comprises an incubator itself that accommodates the bed of the patient, wrapped by an intercalated mattress between its side walls and the dome or upper lid. Said walls and dome are usually transparent, whereby conferring complete visualization and safe access to the newly-born isolated inside the incubator.

For many years, it was believed that a newly-born was a limited creature, capable of performing only the instinctive functions of eating, moving, sleeping and crying. Only in the mid-1960s did doctors and psychologists begin to believe that the brain of the newly-borns was developed beyond a primitive level and that, therefore, it was necessary for the medical team to be trained to read the verbal and non-verbal messages for better communication with a newly-born. It was in view of the importance of identifying such messages that priority was given to complete visibility of a newly-born inside an incubator on a full time basis, and not just at moments when such newly-born presented clinical instability.

With the advancement of technology, incubators began to be powered by battery, have electric heaters, various sensors and audiovisual alarms, among other facilities. Preferably, but not compulsorily, said incubators have auxiliary equipment for therapeutic modalities, such as phototherapy, or at least equipment such as those of phototherapy may be associated thereto.

Phototherapy is a resource used in the treatment of neonatal jaundice caused by hyperbilirubinemia which, in turn, is characterized by yellowing of the skin, mucous and sclera of the newly-born due to the rise in concentration of bilirubin in its organism.

Over 50% of newly-borns suffer from jaundice, whether premature or not, and this normally occurs because the hepatic functions of a newly-born are not sufficiently developed immediately after birth. Therefore, when the quantity of bilirubin in the blood stream reaches high levels, the still immature liver of the newly-born has difficulty in capturing the entire concentration of the pigment and, consequently, it does not excrete the bile in the same proportion, generating an increase of its reabsorption by the intestine, as well as the increase of bilirubin in the blood—or hyperbilirubinemia, as this organic dysfunction is technically called.

This is a common circumstance among neonates, although its severe consequences may evolve to a more serious level known as kernicterus, responsible for causing a cerebral lesion and death of the newly-born. Moreover, mental retardation, cerebral paralysis, deafness and paralysis of the upward movements of the eyes are some later effects which may appear as a consequence of permanent clinical statuses of bilirubinic toxicity. Therefore, having confirmed the diagnosis by means of a blood test of the patient, the treatment consists of a light bath on the body surface of the patient (phototherapy).

The treatment of hyperbilirubinemia began in England at the end of the 1950s, at which time it was noted that the sunlight emitted on the skin of a jaundiced neonate slightly reduced the serum bilirubin levels. Following this confirmation, the first phototherapy apparatuses with fluorescent lamps were developed, acting on the visible light spectrum in the blue range (light wavelength between 400 and 500 nm), which are even used today. It is noted that a phototherapy apparatus is capable of transforming the bilirubin molecules into atoxic isomers, soluble in water, to be eliminated from the organism through the kidneys.

With the progress of technology, other more efficient kinds of light sources were developed, such as fluorescent lamps capable of emitting blue light, halogen lamps, LEDs lamps and, today, the indium gallium nitride LEDs of high light potency and irradiance, which are used, for example, in the phototherapy equipment of the Bilitron® family, produced by the company Fanem® Ltda.

It is worth noting that the effectiveness of phototherapy depends on the light intensity (irradiance emitted by a light source available in a certain direction), on the wavelength (color) of the light, as well as the surface area of the skin exposed to light. Accordingly, to enable monitoring and quantity control (dose) of light to be applied to a newly-born, there is a need to capture the light energy emitted by the light source. This capturing can also be carried out by means of a radiometer that consists of an apparatus capable of measuring irradiance (quantity of light or energy emitted by a unit of area in a certain spectrum), that is, capable of providing irradiance values in a certain range of the light spectrum of a known light source. In phototherapy applications, the radiometer should be configured to measure irradiance in the visible blue spectrum, normally used in phototherapy to treat hyperbilirubinemia, as it has a wavelength (in the range of 400-500 nm) which is more effective in transforming the bilirubin molecules into isomers.

Failure to observe suitable technical criteria for the use of phototherapy, such as the constant measuring of the irradiance emitted by the light source, may adversely affect the quality of the treatment offered to the jaundiced newly-born. Extensive literary review associates the efficiency of phototherapy to the irradiance emitted by these lights comprised in the apparatuses. There is no standard, in the Brazilian hospital market, regulating the number of lamps which should be used in phototherapy equipment. In general, depending on the manufacturer, said apparatuses are comprised of 4 to 8 fluorescent lamps or from 7 to 14 special lamps or else 5 indium gallium nitride LEDs light emitters in the blue spectrum, which correspond to the irradiance level desirable for treatment. However, studies carried out by professionals from the field of neonatology show that it is commonplace to find one or more lamps burned out in phototherapy equipment, particularly in public hospitals. Furthermore, lamps at the end of their useful life, generating lower irradiance than that recommended by medical treatment protocols, are also often found in public hospitals.

It is important to note that the act of exposing the patient to light does not necessarily imply that the patient is receiving suitable treatment. In this sense, there are few hospitals that have this technology to measure the irradiance emitted by the phototherapy equipment, in view of the concept that the average life expectancy of lamps may vary from 200 to 2000 hours of use. Yet, during their lives, such lamps have a different deterioration of their rendition of visible light, as the consumption of each lamp is linked to its manufacturing process, material, type, coating and working parameter.

In addition, the low irradiance emitted by the phototherapy equipment becomes of greater concern when considering that this same irradiance, already deficient on account of the wear of the potency of the lamps, is even greater faced with fogging conditions of the internal cabin of the incubator, which sometimes occurs in an intense manner. Subtherapeutic doses, that is, lower than that recommended, result from deficient treatment, implying the prolongation of hospitalization of the patient and the risks of decline of the clinical picture.

As described previously, treatment by phototherapy consists of applying visible light in the blue range on the patient by way of phototherapy equipment produced by the company Fanem® Ltda (such as for example the models Bilitron® 3006-BTP, Bilispot® 006-BP or Octofoto® 006-OFL), or else any other equipment idealized for such. The application of high intensity light originating from phototherapy promotes the photochemical transformation of bilirubin in the areas exposed to light. These reactions alter the molecular structure of bilirubin, which absorbs the light energy and allows the subproducts to be eliminated by the kidneys or by the liver.

Treating neonatal hyperbilirubinemia indirectly means, therefore, monitoring these lamps used in the phototherapy apparatuses, with a view to keeping them always with suitable irradiance. The apparatus that is not monitored in terms of irradiance may have scant influence on the clinical status of the newly-born and, consequently, prolong its hospitalization time.

Various factors may be unleashed from a prolonged treatment in the incubator, such as, for example, the risk of burning of the surface of the skin of the patient, as well as dehydration and malnutrition on account of the decreased frequency of milk feeding. In addition, it must be considered that a prolonged period of the patient inside the incubator also results in drawbacks for the hospital, in that the incubator is not available to treat other infants. In addition, it demands greater consumption of energy and monetary cost.

The effectiveness of phototherapy is therefore directly linked to the irradiance emitted by means of lamps, be they white and blue fluorescent, halogen, Leds, with or without the use of fiber optics, among others, depending on the manufacturer of the phototherapy equipment. Additionally, the internal condition of the cabin of the incubator is equally fundamental for the irradiance to reach the newly-born effectively and for the phototherapy to achieve the recommended effects.

Studies show that the fogging of the walls and/or of the dome of the incubator, caused by the temperature shock on these surfaces, diminishes the effectiveness of the irradiance emitted by the phototherapy equipment and that effectively reaches the newly-born in phototherapy. In addition, fogging also prevents complete visualization of the newly-born isolated inside the cabin, meaning treatment may be hampered, and, in some drastic situations, jeopardize its safety. Generally, fogging results from the system (passive or active) of humidification incorporated by the internal cabin of the incubator.

Humidification of the incubator allows best conservation of heat within the internal cabin. Under these conditions, newly-born tends to stabilize the hydric loss evaporated by the skin which, in turn, may reflect from between 20% and 30% of its weight in the first days of life. The levels in relative air humidity inside the internal cabin of the incubator usually vary between 75% and 95%, depending on the weight and conditions in which the patient is found.

The humidity inside the internal cabin generates a build-up of water droplets that condense when in contact with colder surfaces (the walls and the dome of the incubator), and the accumulation of cooled vapor on these surfaces is what causes fogging. Using cleaning cloths to demist the internal cabin of the incubator creates a means of proliferation for countless micro-organisms that are particularly harmful to the health of a newly-born. The hospital market has, in this regard, cleaning cloths manufactured with antiseptic materials which, though guaranteeing long duration of the bacteriostatic agent on the cloth itself, do not protect the surfaces to be cleaned by the bactericide action. It is worth noting that the heated, lit and humidified environment inside an incubator is significantly prone to the proliferation of germs and bacteria, so such cleaning method might jeopardize the life of the newly-born.

Certain technologies in the state of the art propose an alternative to minimize fogging inside an incubator, such as U.S. Pat. No. 3,782,362 which describes an incubator with a structure for an air circulation system to prevent the loss of heat of the patient, and, secondarily, reduce misting and condensation of humidity inside the microenvironment.

Further, document U.S. Pat. No. 3,187,744 describes an incubator for neonates with an antifogging thermometer coupled to the respective hospital equipment.

Document U.S. Pat. No. 6,913,571 describes a heating system for incubators for newly-borns, which heats the internal cabin where the infant is positioned by means of an electrical resistance conducting element.

Notwithstanding conventional equipment, there are various inventions describing incubators for neonates, including the cases of Brazilian patents PI 0804985-8, PI 9603236-7, PI 0102963-0 and MU 8100848-1, all belonging to the filing applicant of the present invention and each defining protection for a given improvement in the equipment, which denotes his relevant interest in this segment.

Although the improvements introduced in the incubators belonging to the state of the art prove the well-known concern in the search for a technology which tries to control fogging promoted by humidification of the internal cabin, no solution found thus far has been capable of maintaining complete visualization of the newly-born and suitable and sufficient amounts of irradiance emitted by the phototherapy equipment which effectively reaches it without, in doing so, the effectiveness of one of the systems being adversely affected by the activity of the other.

### BRIEF SUMMARY

The objective of the present invention is hospital equipment particularly idealized for treating neonates, such as a closed incubator or heated crib for various medical purposes and with or without various installations coupled to its platform designed to treat and support the patient's life, microprocessed or not, that has an antifog film partially or totally transparent and hydrophilic adhered to one or all the internal parts of said incubator in order to guarantee that there is no loss of the irradiance that is emitted by the phototherapy equipment (promoted by phototherapy equipment preferably coupled to the incubator) that reaches the newly-born and provides complete visualization of the patient, and where such film is made from materials that enable survival of the patient without causing sequelae to its life.

The objectives of the present invention are achieved by hospital equipment, comprising at least an incubator of the closed kind having at least a side wall and at least a lid or dome that define a cabin inside of which there is provided at least a bed to receive at least a patient, with at least, one of the walls and/or dome being transparent and operatively associable to, at least phototherapy equipment, additionally comprising a film with antifog properties associated to the side wall and/or dome.

Further, the objectives of the present invention are achieved by an incubator of the closed kind having at least a side wall and at least a lid or dome defining a cabin inside of which there is provided at least a bed to receive at least a patient, with at least one of the walls and/or dome being transparent and operatively associable to, at least, phototherapy equipment, additionally comprising a film with antifog properties associated to the side wall and/or dome.

The present invention presents the advantage of guaranteeing that there are no considerable losses in the value of the irradiance emitted by the phototherapy equipment that reaches the newly-born, and also provides complete visualization of the patient, even when the internal cabin of the incubator presents 95% in relative air humidity.

### BRIEF DESCRIPTION OF THE SEVERAL VIEWS OF THE DRAWING(S)

The present invention will now be described in greater detail based on an example of execution represented in the drawings. The drawings show:

FIG. 1—is a perspective view of a non limitative preferred configuration of the hospital equipment that is the objective of the present invention.

FIG. 2—is an anterior view of a non limitative preferred configuration of the hospital equipment that is the objective of the present invention.

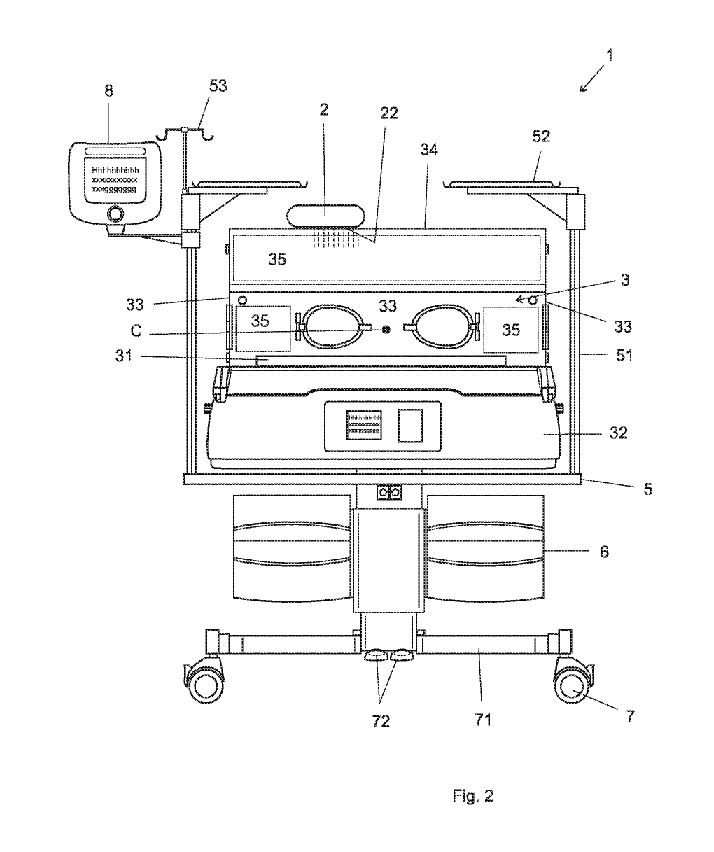

FIG. 3—is a side view of a non limitative preferred configuration of the hospital equipment that is the objective of the present invention.

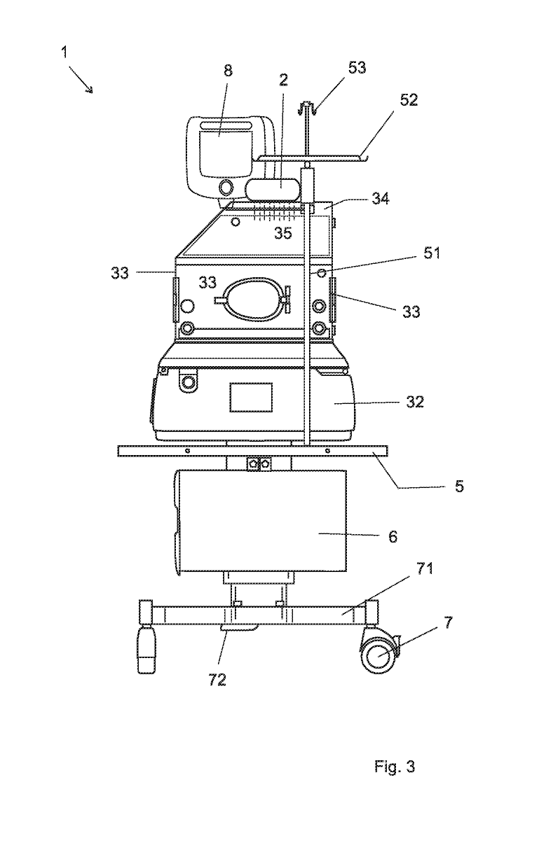

FIG. 4—is a top view of a non limitative preferred configuration of the hospital equipment that is the objective of the present invention.

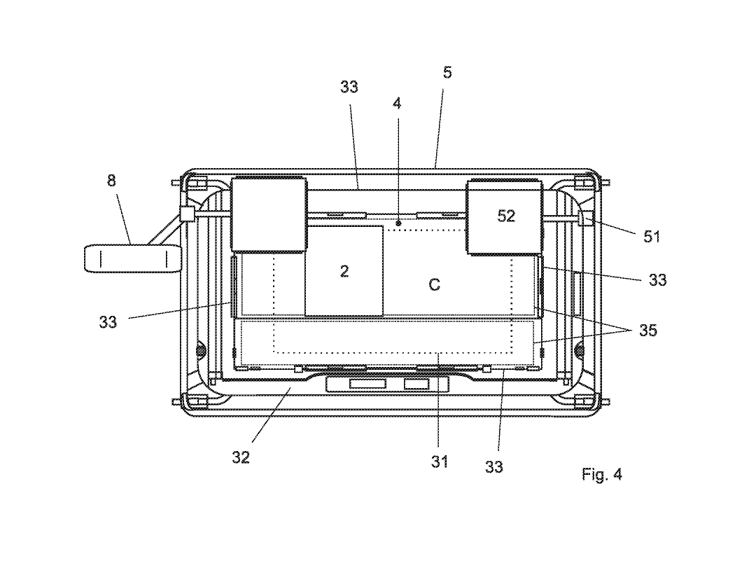

FIG. 5—is a perspective view of the incubator that is an integral part of the hospital equipment that is the objective of the present invention.

FIG. 6—is an anterior view of the incubator that is an integral part of the hospital equipment that is the objective of the present invention.

FIG. 7—is a side view of the incubator that is an integral part of the hospital equipment that is the objective of the present invention.

FIG. 8—is a top view of the incubator that is an integral part of the hospital equipment that is the objective of the present invention.

### DETAILED DESCRIPTION OF VARIOUS EMBODIMENTS

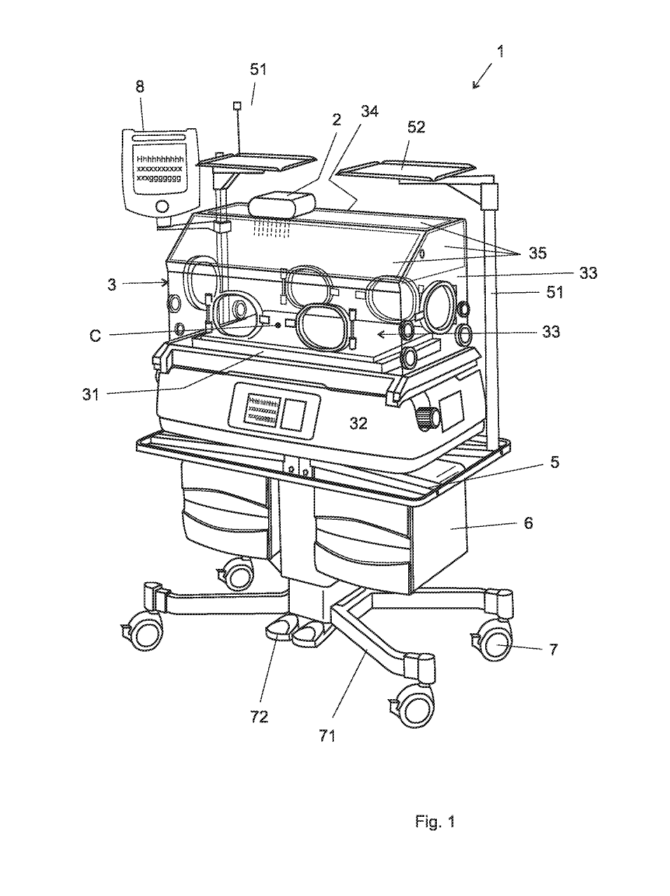

According to various embodiments and as can be seen from FIG. 1, the present invention refers to hospital equipment 1, which has a closed incubator 3, idealized to treat newly-borns and has, or is associable to, one or more items of equipment to support the patient's life, such as at least phototherapy equipment 2. Associated to the incubator 3 is at least an antifog film 35 (the composition of which is described ahead) that avoids fogging of the walls 33 and/or of the dome 34 thus allowing the best effectiveness of the phototherapeutic treatment. In short, the equipment 1 has an incubator 3 and other components/devices, which will be described further ahead.

In the embodiment illustrated in FIG. 1, the phototherapy equipment 2 comprises a body or structure 22, suspended by a vertical arm 51 which extends beyond the bed 31 of the incubator 3. Said structure 22 has a plurality of indium gallium nitride LEDs light emitters in the blue spectrum (described ahead), although obviously this constitution may vary. The light wavelength emitted by the indium gallium nitride LEDs is preferably about 450 nm, thus making it unnecessary to install filters for controlling the light emitted (notably ultraviolet and infra-red rays which are invisible). However, the phototherapy equipment 2 used may freely vary provided that it is effective in the phototherapy treatment.

In this regard, between parentheses, it is worth noting that the first phototherapy apparatuses used fluorescent lamps, which produced a more efficient phototherapy effect than the irradiation of light by means of common lamps, by emitting a high rate of luminous radiation in a “cold” way, that is, a whiter light spectrum. However, the level of irradiation from each fluorescent lamp in isolation was very low, making it necessary to use various lamps simultaneously, which required the use of a large apparatus so that irradiant energy was sufficient for the desired curative effect.

To overcome this major drawback, research and studies were carried out on the application of blue, high irradiance fluorescent lamps, developed and manufactured with the purpose of being used in phototherapy apparatus. However, these lamps, despite emitting light with more suitable properties for realizing phototherapy, still have the irremediable disadvantage of being long in length.

As technology advanced, the market witnessed the introduction of halogen lamps (lamps of the filament kind surrounded by an atmosphere of halogen gas) which had a far superior performance to fluorescent lamps in the treatment of hyperbilirubinemia, with significantly reduced size. This type of lamp, however, produced a lot of heat, meaning cooling was necessary by means of fans and filtering certain wavelengths by way of infra-red and ultraviolet filters, in order to reduce the undesirable effects on the body of the neonate. Moreover, this kind of lamp has a relative short useful life, and has to be replaced at shorter than desirable intervals.

To eliminate over heating caused by phototherapy light irradiation, technology evolved to applying lamps in solid state or common blue LEDs (light emission diodes), which significantly collaborate to reduce the heat and consumption of electric energy of the former phototherapy light sources for treating hyperbilirubinemia. However, common LEDs do not have good irradiation if considered unitarily, it being necessary to use many common LEDs jointly so that the treatment effect is satisfactory. In addition, common LEDs need greater proximity to the patient's body, meaning that the use of this apparatus is limited to certain applications, where it is necessary to position the light source very closely to the patient's body.

With a view to remedying these drawbacks, the applicant developed the equipment Bilitron®, which uses LEDs, which are different to conventional LEDs made of gallium nitride (GaN) by being composed of indium gallium nitride (InGaN), and also by emitting high light energy in a small visible range of the electromagnetic radiance spectrum (blue), with the absence of emittance of infra-red radiation. The indium gallium nitride LEDs are components that are already known and used in odontological equipment for resin polymerization, but they had never been used in phototherapies for the treatment of bilirubinemia and others therapies.

Returning to the description of the hospital equipment, in the embodiment illustrated in FIG. 1, an incubator 3 comprises at least one, but preferably four side walls 33, and a dome or lid 34 articulatedly associated to the at least one of the walls 33, forming a cabin C which in the certain embodiments is substantially parallelepiped. Obviously the number, shape and positioning of the walls 33 may and will vary in accordance with the shape of cabin C.

All this combination is positioned on a base 32 that comprises, preferably, control switches and a display with sensors for temperature, humidity, oxygen, battery, audiovisual alarm, among other sensors in accordance with the need and the model of the equipment. The existence or not of the base 32 and other elements, however, is irrelevant for defining the scope of protection of the accompanying claims.

Evidently the shape, the quantity and the relative positioning of the walls 33 and the lid 34 may freely vary, as long as they define a cabin C inside of which a newly-born may be treated. As an alternative example, it would be possible to create an incubator whose cabin C took on a substantially spherical shape, and, even so, this equipment would be included within the scope of protection defined by the accompanying claims.

Whatever the quantity and the shape of the walls 33 and the respective dome or lid 34, at least one of them is coated by an antifog film 35 preferably transparent, so as to eliminate, at least mitigate considerably, its fogging when the environment inside the cabin C presents high humidity.

In addition, preferably but not compulsorily, the present invention further comprises other additional parts that complement the structure of the hospital equipment 1 and that are equally significant, such as the phototherapy equipment 2 operatively integrated to the combination (it can be perfectly be external and/or not physically linked to the incubator 3), at least a microprocessing control panel 8 and at least a flat structure 5 that supports vertical arms 51 and trays 52, side drawers 6 and swivel wheels 7 connected to horizontal arms 71 and pedals 72 (that enable easy movement of the combination).

In an exemplary variation, the microprocessing panel 8 is associated to a computer program which receives, among countless other items of information, the data input by the medical team on the levels of bilirubin presented by the patient and generates graphs that present the downward or upward trend of the level (mg/dl) of this pigment in the blood stream, helping health professionals to draw up parameters for a more effective diagnosis, alarm warnings, etc. Said panel is preferably associated to the vertical arm 51 of the hospital equipment 1 and raised beyond the bed 31 of the incubator 3.

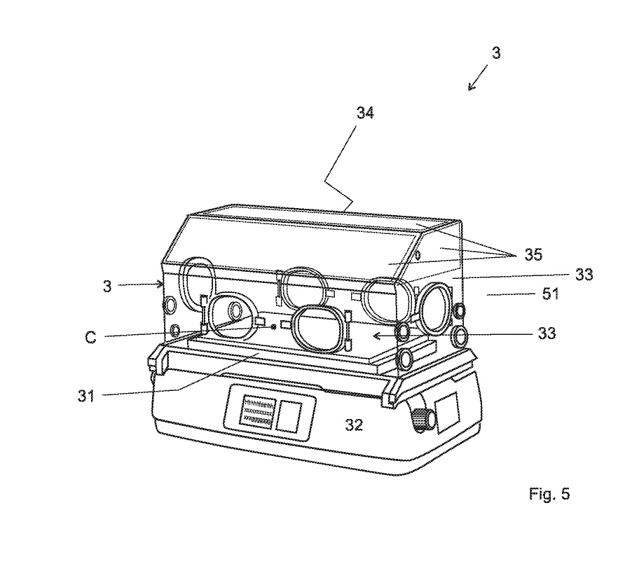

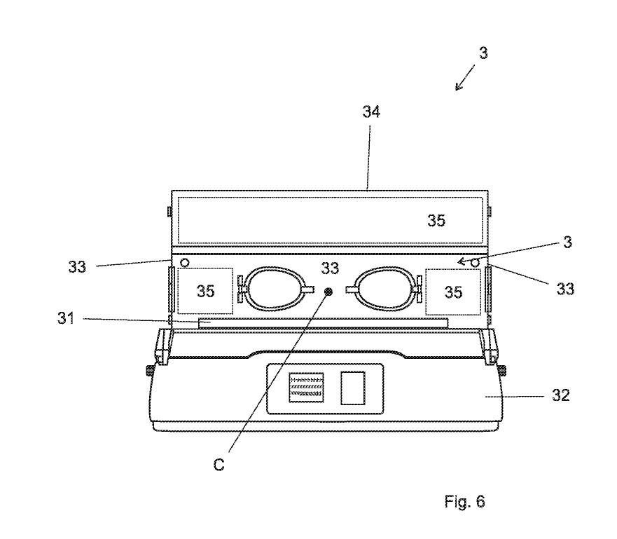

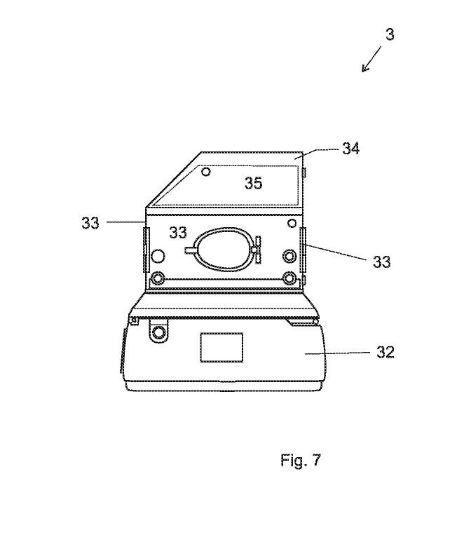

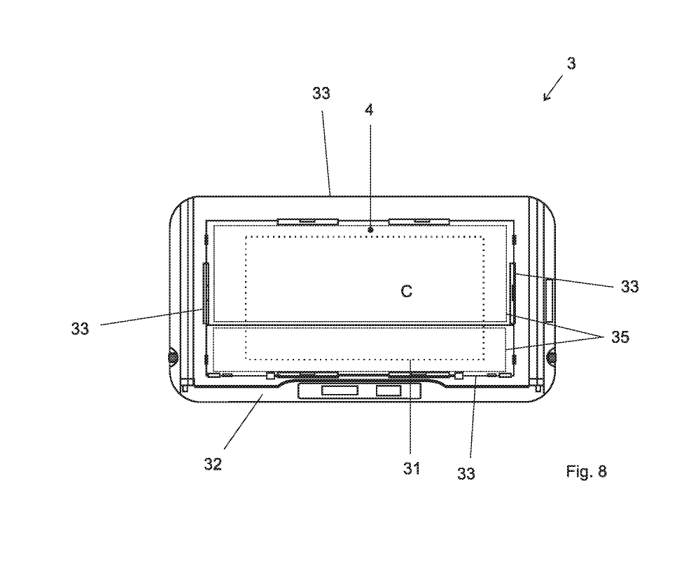

The incubator 3 illustrated in the FIGS. 5 to 8 is preferably supported by the base 32 which, in turn, rests on a flat structure 5. Said flat structure 5 preferably does not just support, but also involves the incubator 3 with its coupled side arms 51 that vertically rise towards the dome 34. Said side arms 51 support, at each end, a tray 52 for various medical purposes. In the embodiment illustrated in FIG. 1, one of the side arms 51 vertically extends beyond the tray 52 and couples a coat-hanger shaped arrangement 53, in order to enable suspension of the medical resources such as a serum or blood bag for example.

Just below the incubator 3 and the flat structure 5 which supports it, there is projected a portion associated to the aforementioned drawers or side recipients 6 which, in turn, are preferably disposed in parallel under the incubator 3. In a given embodiment, said side recipients 6 may contain handles to facilitate the respective opening, and their functionality is not specific, and therefore may house medicines, hospital instruments, patient examination results and/or any pertinent object.

The last lower portion of the flat structure 5 is associated to horizontal arms 71, forming the base that supports the entire hospital equipment 1, and also the swivel wheels 7 which facilitate both movement and localization of the equipment 1, be it in the Intensive Therapy Unit, or in the maternity ward. Connected to this last lower portion are also pedals 72 that allow suitable height adjustment of the equipment 1 for complete visualization of the newly-born on the bed 31.

One of the benefits of the present invention is to encompass, in a single hospital equipment 1, an incubator 3 with the ability to prevent fogging of its walls 33 and of its dome 34 (thanks to the existence of the antifog film 35), with installations and additional sensors in order to fulfill the needs of the newly-born, providing not just a comfortable microenvironment, but also guaranteeing a safe and self-sufficient hospital base.

Although the various embodiments of the incubator 3 now described presents the adaptations necessary for upkeeping the health of the newly-born for an undetermined time, the objective of any hospital equipment 1 such as the present should be that of providing for the metabolic deficiencies of the patient as quickly as possible, in order to avoid drawbacks such as distancing of the presence and heat of its mother, the risk of dehydration and malnutrition on account of the decreased frequency of milk feeding, greater consumption of energy and higher monetary cost for hospitals.

Hyperbilirubinemia is one of the disturbances from which a newly-born may suffer, keeping it away from its mother. As described in the state of the art and discussed elsewhere, hyperbilirubinemia is defined by a sudden and drastic increase in the levels of the pigment bilirubin in the blood which may cause complications and generate permanent sequelae in the patient if not treated in time. In such case, the newly-born needs to be placed in an incubator and treated with phototherapy equipment, having to remain a long time in said hospital equipment.

In the hypothesis of treating hyperbilirubinemia in a state-of-the-art incubator, the fogging of the walls and/or of the dome of the internal cabin diminishes the irradiation emitted by the phototherapy equipment which effectively reaches the newly-born and, therefore, reduces the effectiveness of the treatment. This occurs because the water droplets resulting from humidification of the internal cabin tend to condense on the walls and/or a dome of the incubator, making them foggy on account of the temperature shock on these surfaces and diverting the irradiation emitted by the phototherapy equipment, by acting as countless tiny diffraction prisms. In view of this condition, phototherapeutic treatment tends to take longer to achieve the desired effects, exposing the newly-born to the aforementioned drawbacks. In addition, to make matters worse, the fogging of the walls and lid of the cabin along means the visualization of the newly-born is adversely affected.

In seeking an efficient solution to this problem, various studies and tests have been performed by the filing applicant of the present application in the attempt to eliminate the effect of fogging caused by humidification of the incubator in order to create better visibility conditions and broaden the irradiance that reaches a newly-born during phototherapy. The experiments were carried out in a Neonatal Incubator, with the assistance of Phototherapy Equipment and a Radiometer, all manufactured by the company Fanem® Ltda. A doll was used to simulate a newly-born inside the incubator.

Before beginning the procedures, the doll used to simulate a newly-born was positioned on the bed of the incubator next to the optic sensor of the radiometer. The phototherapy equipment was positioned above the dome of the incubator, such that the optic sensor was at the center of the irradiated focal point.

Under normal working conditions and without applying the antifog film 35 the irradiance emitted by the phototherapy equipment and which effectively reached the newly-born during the testes remained constant, when at levels of up to 70% of humidification of the internal cabin of the incubator. It was noted, however, that the percentage of irradiance which effectively reached the newly-born gradually decreased as the humidity inside the cabin and the fogging of the walls and/or the dome of the incubator increased, reflecting a drop of about 50% of the irradiance which effectively reached the patient when the inside of the cabin was regulated at 95% in relative air humidity. Such situation is rather harmful since the current treatment protocols for neonates require the maintenance of the inside of the incubator with a humidity of about 85% and the relentless fogging of the walls and lid significantly decrease the radiance that effectively reaches the body of the patient (in this humidity condition, the drop in irradiance is about 40%).

During subsequent experiments, efforts were made to maintain the walls and the dome of the incubator heated, in order to avoid the temperature shock between the water vapor and the transparent surfaces that were under the influence of the outside ambient temperature.

Firstly, hot air was applied on all the extension of the walls and the dome of the incubator simultaneously to the humidification process of the internal cabin. However, it was ascertained that in the daily practice of hospital procedures, such method would be entirely unfeasible without constant monitoring, as it would jeopardize the life of the newly-born inside the incubator, given the possibility of a short-circuit in the system. Furthermore, the internal heat applied directly on the walls and dome of the incubator, for the time necessary to maintain the internal cabin climatized for the survival of the neonate, might wear and/or damage (diminish the transparency and even melt) the walls and dome of the incubator. In addition, this procedure would generate greater energy consumption, causing higher treatment costs.

A new attempt was then carried out, however, this time, projecting electricity-conducting metal wires along the internal cabin. However, it was concluded that the electricity-conducting wires might easily be damaged under conditions of this nature, where the humidity of the microenvironment is necessary the entire time while the hospital equipment is operating. Additionally, in the event of overheating of the wires, both the newly-born and the medical team might sustain burns to the skin surface. In addition, the same problems as in the prior test were identified, such as greater consumption of electric energy and the possibility that the heat might wear and damage the walls and the dome of the incubator.

On the other hand, it would be possible to alter the manufacturing materials of an incubator, replacing the acrylic for an electric resistance formed by tungsten filaments with micron thickness so that when activated it could promote complete defogging of the walls and the dome of the incubator. However, besides again involving increased consumption of electric energy, this technique would be very expensive, meaning commercialization of this technology in incubators would be unfeasible.

In sequence, upon analyzing the results performed thus far, it was noted that the irradiance which effectively reached the newly-born during phototherapy gradually began decreasing after the start of fogging of the walls and/or of the dome of the incubator, as a result of the increase in humidity. In fact, it is not the humidity in itself that decreases the irradiance that effectively reaches the patient, but rather the fogging on the walls and lid that it causes, which shall be seen below.

After a brief interruption in one of the tests, in order to clean the fogging of the walls and the dome of the incubator, it was noted, when the tests resumed, that the percentage of the irradiance that effectively reached the newly-born returned to normal levels and remained constant for longer, even though the humidity was 90%. Based on this result, it was possible to conclude that the fogging of the walls and/or the dome of the incubator interfered more in the efficiency of the irradiation which reached the patient than the humidity itself regulated in the internal cabin of the incubator.

In addition, it must be emphasized that methods of cleaning the internal cabin should be avoided with the presence of a newly-born in the bed of the incubator due to the possibility of bactericide action through the cleaning means.

Faced with proof that fogging of the internal cabin is responsible both for preventing complete visualization of the patient inside the incubator, and also for reducing the irradiance which reaches the patient inside the cabin, the option was to test the effects of the antifog film adhered to the inside of the walls and the dome of the incubator. Accordingly, after setting the incubator to operate at a temperature of 36° C. and 95% in relative air humidity, the radiometer recorded irradiance values that effectively reached the newly-born during phototherapy analog to those found under the condition of non-humidity and fogging.

Additionally, the tests carried out with the antifog film provided excellent visualization of the patient inside the incubator, differently to when an incubator was activated without the protection of the antifog film, a situation in which the complete fogging of the internal cabin prevented even partial visualization of the patient, and recorded a drop of 50% in irradiance that effectively reached the patient.

Hence, the equipment and the incubator 3 that are the subject matter of the present application is a differentiating factor on the market by virtue of its efficient and innovative internal coating, wherein the antifog film 35 coats the walls 33 and/or a dome 34 of the incubator 3 and prevents grouping of the water droplets that cause fogging inside cabin C. Consequently, the maintenance of the irradiance that effectively reaches the newly-born on the bed 31 is kept constantly at levels of up to 95% or more of humidity inside the incubator 3, thus increasing the efficiency of the phototherapy. Moreover, it is obvious that this technology is safer than the techniques tested previously and also than those belonging to the state of the art.

The film with antifog properties 35 used is preferably transparent and presents resistance to heat and high adhesiveness on one of its sides, and the duration of the antifog effect is permanent under normal use conditions.

Preferably, the chemical composition of said antifog film 35 comprises a tensoactive polymer that absorbs the humidity and does not dissolve in water, even after long immersion or repeated washings. Said polymer may perfect perform the desired function, since its action is not adversely affected by common window cleaners, detergents, ammonia, alcohol, and other cleaning products, and also keep its properties faced with exposure to sunlight or heat. Moreover, its composition is preferably antitoxic and extremely hydrophilic, meaning that the condensed water droplets on the walls 33 and/or the dome 34 of the incubator 3 spread out instead of grouping, and prevent fogging of the internal cabin C.

The antifog film 35 which coats the internal part of cabin C of the incubator 3 is preferably transparent in order to facilitate the complete visualization of the newly-born independently of the perspective in which it has to be watched. Said antifog film 35 coats preferably, but not compulsorily, the entire internal structure of the incubator 3, but may, however, only coat one of the walls 33 and/or of the dome 34, provided that its antifog effect produces the desired effect.

In incubators belonging to the state of the art different solutions are found which try to reduce partially and/or detect fogging caused mainly by humidification of the microenvironment. Nevertheless, said systems do not work satisfactorily and the phototherapeutic treatment is prolonged in view of the gradual decrease of irradiation emitted by the phototherapy equipment that effectively reaches the newly-born.

In addition, one of the advantages of the present invention over technologies that use electric power-conducting wires to keep the walls 33 and/or the dome 34 of the incubator heated, in order to try to control fogging of the internal cabin C, can be classified essentially by the fact of not increasing the consumption of electric energy and the construction complexity and maintenance of the incubator.

However much care is taken with electrical installations, it is known that, in extreme situations, overheating of the power-conducting wires may occur independently, if, for example, the electric current is over the levels that the wiring can support, causing short circuits. The occurrence of overheating of the wires inside an incubator may ultimately cause serious burns both to the newly-born and to the medical team handling the hospital equipment. Still regarding overheating of the wires, the walls and/or dome of the incubator may be damaged and, therefore, fail to keep the cabin C duly climatized for survival of the patient. In addition, in the case of wear and tear of the material, the contact of the electric wires with the relative humidity of the air generated inside the incubator may cause electric shocks.

In light of the above, it is certain that the hospital equipment 1 and the incubator 3 illustrated in the accompanying drawings, with partial or total coating of its internal cabin C by a film with antifog properties 35, preferably transparent in order to increase the irradiance promoted by the phototherapy equipment 2 which reaches the newly-born, even under conditions of high humidity inside cabin C, present innovative and efficient characteristics compared to technologies currently available on the market.

So much so that the incubator 3, in itself, is innovative and is encompassed within the scope of protection of the claims.

Having described an example of various embodiments, it must be understood that the scope of the present invention encompasses other possible variations, being limited only by the content of the accompanying claims, potential equivalents being included therein.

That which is claimed:

1. Hospital equipment, comprising at least an incubator (3) of the closed kind having at least one side wall (33) and at least a lid or dome (34) defining a cabin (C) inside of which there is provided at least a bed (31) to receive at least a patient, at least one of the side walls (33) or the dome (34) being transparent, and operatively associable to, at least, phototherapy equipment (2), wherein the incubator additionally comprises a film with anti-fog properties (35) associated to the side wall (33) and/or dome (34).

2. Hospital equipment according to claim 1, wherein the at least one side wall (33) comprises four side walls (33), with the dome or lid (34) articulatedly associated to at least one of the side walls (33), forming a cabin (C) substantially parallelepiped.

3. Hospital equipment according to claim 1, wherein the film with anti-fog properties (35) is internally associated to the four side walls (33) and dome or lid (34) of the incubator (3) with transparent glue.

4. Hospital equipment according to claim 1, wherein the film with anti-fog properties (35) is transparent and its chemical composition comprises a hydrophilic tensoactive polymer which maintains its properties faced with water, cleaning products, heat and exposure to the sun.

5. Hospital equipment according to claim 1, wherein the incubator (3) guarantees the maintenance of the irradiance emitted by the phototherapy equipment (2) that reaches the patient when the internal cabin (C) of the incubator (3) presents up to 95% or more in relative air humidity.

6. Hospital equipment according to claim 1, wherein the incubator (3) is positioned on a base (32) that comprises control switches and a display with sensors for temperature, humidity, oxygen, battery, audiovisual alarm, among other sensors.

7. Hospital equipment according to claim 1, the equipment further comprising a micro-processing control panel (8), a flat structure (5) that supports vertical arms (51) and trays (52), side drawers (6), besides swivel wheels (7) connected to horizontal arms (71) and pedals (72) that enable easy movement of the combination.

8. Incubator (3) of the closed kind, the incubator comprising at least a side wall (33) and at least a lid or dome (34) defining a cabin (C) inside of which there is provided at least a bed (31) to receive at least a patient, at least one of the side walls (33) or the dome (34) being transparent, and operatively associable to, at least, phototherapy equipment (2), wherein the incubator additionally comprises a film with anti-fog properties (35) associated to at least one of the side walls (33) or the dome (34).
